(19) United States
(12) Patent Application Publication
(10) Pub. No.: US 2026/0357065 A1
(43) Pub. Date: Nov. 12, 2026

(54) VISCOELASTIC POLYURETHANE FOAM

(71) Applicant: Dow Global Technologies LLC, Midland, MI (US)

(72) Inventors: Qinghao Meng, Angleton, TX (US); Noel Mower Chang, Midland, MI (US); Camila Flores, Jundiaí (BR); David J. Honkomp, Marietta, GA (US)

(21) Appl. No.: 19/123,211

(22) PCT Filed: Dec. 12, 2023
(86) PCT No.: PCT/US2023/083610

§ 371 Date: Apr. 22, 2025

Related U.S. Application Data
(60) Provisional application No. 63/433,161, filed on Dec. 16, 2022.

(51) Int. Cl. C08L 75/08; C08J 9/00; C08J 9/12

(52) U.S. Cl. CPC C08L 75/08; C08J 9/0061; C08J 9/125; C08J 2203/10; C08J 2375/08; C08J 2383/12; C08L 2203/14

(57) ABSTRACT

The present disclosure is concerned with a composition for making a viscoelastic polyurethane foam, the viscoelastic polyurethane foam is prepared from a composition that includes an isocyanate component and an isocyanate reactive composition having a first polyether polyol with moieties derived from ethylene oxide, a second polyether polyol with moieties derived from propylene oxide, a polyether siloxane surfactant and water, the polyether siloxane surfactant has the structure of Formula (I): R₁(CH₃)₂Si—[OSi(CH₃)₂]ₓ—[OSi(CH₃)(Y)]_{y}—OSi(CH₃)₂R₂, where Y is independently selected from the structure of Formula (II): —(CH₂)ₙO—(CH₂CH₂O)ₑ—(CH₂CH(R₃)O)ₚ—Z.

### FIELD OF DISCLOSURE

Embodiments of the present disclosure are directed towards a composition for preparing a viscoelastic polyurethane foam.

### BACKGROUND

Flexible polyurethane (PU) foams are widely used in mattresses, pillows and seat cushions. A type of flexible PU foam that is of increasing market interest is the viscoelastic PU foam, typified by its slow recovery after compression. Due to the gradual recovery after compression, viscoelastic PU foam also can be described as “slow recovery” PU foam.

By way of background, polyurethane foams are polymers formed from the reaction of polyols and isocyanates. Commonly used isocyanates include methylenediphenyl diisocyanate (MDI) and toluene diisocyanate (TDI). TDI is useful for producing flexible PU foams for use in bedding, furniture, carpet padding and packaging applications, among other applications. TDI material is also important in the manufacture of coatings, sealants, adhesives, and elastomers. In contrast, using MDI for producing flexible PU foams is very difficult. As a result, MDI is mainly used for producing viscoelastic polyurethane foams. MDI, however, has certain advantages relative to TDI, which include having lower levels of volatile organic compounds VOC in its typical formulation and the ability to impart better durability and retention of physical properties to the resulting PU foam.

Another issue of current viscoelastic PU foams produced with TDI is that their firmness is sensitive to temperature. This is linked with the fact that viscoelastic PU foams often have glass transition temperature (Tg) that is around room temperature (15-30 °C). the Tg of a viscoelastic PU foam is the temperature range where the PU material makes a transition from a relatively hard and brittle “glassy” state to a viscous or rubbery state as the temperature increases. Thus, as the room temperature becomes higher or lower, the hardness or firmness of the viscoelastic PU foam moves in the opposite direction. This change in firmness in and around these temperatures where the viscoelastic PU foam is most likely to be used (e.g., room temperature) is a negative characteristic. As a result, there is a need in the art for viscoelastic PU foam system that can address the drawbacks of using TDI in forming viscoelastic PU foams.

### SUMMARY

The present disclosure provides for an isocyanate reactive composition that together with an isocyanate component that includes diphenyl methane diisocyanate (MDI), poly MDI or combinations thereof enables the production of a viscoelastic PU foam having a low density (e.g., 40 kg/m³ or less) and a much broader Tg than typical for viscoelastic PU foams. Although having a higher Tg than the typical viscoelastic PU foam, the viscoelastic PU foam of the present disclosure has a lower temperature sensitivity than the typical viscoelastic PU foam because of the broad glass transition temperature.

For the various embodiments, the isocyanate reactive composition for preparing the viscoelastic polyurethane foam includes:
(a) 50 to 90 weight percent (wt. %) of a first polyether polyol based on the total weight of the isocyanate reactive composition, where the first polyether polyol has 50 wt. % to 80 wt. % of moieties derived from ethylene oxide based on a total weight of the first polyether polyol, has a primary hydroxyl content of 30 percent to 78 percent based on a total number of hydroxyl groups in the first polyether polyol, and a hydroxyl number of 28 to 56 mg KOH/g;
(b) 10 to 50 wt. % of a second polyether polyol based on the total weight of the isocyanate reactive composition, where the second polyether polyol has 90 wt. % to 100 wt. % of moieties derived from propylene oxide based on a total weight of the second polyether polyol, has a primary hydroxyl content of 0 percent to 40 percent based on a total number of hydroxyl groups in the second polyether polyol, and a hydroxyl number of 25 to 88 mg KOH/g;
(c) 0.2 wt. % to 4.0 wt. % of a polyether siloxane surfactant, based on the total weight of the isocyanate reactive composition, of Formula (I):

R₁(CH₃)₂Si—[OSi(CH₃)₂]ₓ—[OSi(CH₃)(Y)]_{y}—OSi(CH₃)₂R₂ (Formula I)

where x is 5 to 55; y is 2 to 30; each Y is independently selected from the structure of Formula II:

—(CH₂)ₙO—(CH₂CH₂O)ₑ—(CH₂CH(R₃)O)ₚ—Z (Formula II)

where: n is 1 to 10; e is 5 to 12; p is 0 to 8; where the (CH₂CH₂O): moiety of Formula II is at least 60 wt. % of the total weight of Formula II; where R₁, R₂, R₃ are independently selected from the group consisting of methyl, ethyl or phenyl; and Z is H; and
(d) up to 7 wt. % of water based on the total weight of the isocyanate reactive composition, where a total wt. % of (a), (b), (c) and (d) does not exceed 100 wt. %.

The above summary of the present disclosure is not intended to describe each disclosed embodiment or every implementation of the present disclosure, the description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

The present disclosure provides for an isocyanate reactive composition that together with an isocyanate component that includes diphenyl methane diisocyanate (MDI), poly MDI or combinations thereof enables the production of a viscoelastic PU foam having a low density (e.g., 40 kg/m³ or less) and a much broader Tg than typical for viscoelastic PU foams. Although having a higher Tg than the typical viscoelastic PU foam, the viscoelastic PU foam of the present disclosure has a lower temperature sensitivity than the typical viscoelastic PU foam because of the broad glass transition temperature.

The above mentioned advantages of the present disclosure are surprisingly achieved using the isocyanate reactive composition for preparing a viscoelastic polyurethane foam that includes: (a) 50 to 90 weight percent (wt. %) of a first polyether polyol based on the total weight of the isocyanate reactive composition, where the first polyether polyol has 50 wt. % to 80 wt. % of moieties derived from ethylene oxide based on a total weight of the first polyether polyol, has a primary hydroxyl content of 30 percent to 78 percent based on a total number of hydroxyl groups in the first polyether polyol, and a hydroxyl number of 28 to 56 mg KOH/g; (b) 10 to 50 wt. % of a second polyether polyol based on the total weight of the isocyanate reactive composition, where the second polyether polyol has 90 wt. % to 100 wt. % of moieties derived from propylene oxide based on a total weight of the second polyether polyol, has a primary hydroxyl content of 0 percent to 40 percent based on a total number of hydroxyl groups in the second polyether polyol, and a hydroxyl number of 25 to 88 mg KOH/g; (c) 0.2 wt. % to 4.0 wt. % of a polyether siloxane surfactant, based on the total weight of the isocyanate reactive composition, of Formula (I):

R₁(CH₃)₂Si—[OSi(CH₃)₂]ₓ—[OSi(CH₃)(Y)]_{y}—OSi(CH₃)₂R₂ (Formula I)

where x is 5 to 55; y is 2 to 30; each Y is independently selected from the structure of Formula II:

—(CH₂)ₙO—(CH₂CH₂O)ₑ—(CH₂CH(R₃)O)ₚ—Z (Formula II)

where: n is 1 to 10; e is 5 to 12; p is 0 to 8; where the (CH₂CH₂O) e moiety of Formula II is at least 60 wt. % of the total weight of Formula II; where R₁, R₂, R₃ are independently selected from the group consisting of methyl, ethyl or phenyl; and Z is H; and (d) up to 7 wt. % of water based on the total weight of the isocyanate reactive composition, where a total wt. % of (a), (b), (c) and (d) does not exceed 100 wt. %.

The present disclosure further provides a viscoelastic polyurethane foam formed from a composition that includes an isocyanate component, where the isocyanate component comprises diphenyl methane diisocyanate, poly(diphenyl methane diisocyanate) or combinations thereof; and the isocyanate reactive composition of the present disclosure. the process of preparing the viscoelastic polyurethane foam can include, as discussed herein, a step of reacting the components that includes the isocyanate component and the isocyanate reactive composition, both as discussed herein.

Each of the above components, along with other optional components, of the isocyanate reactive composition are discussed as follows. For the various embodiments, hydroxyl numbers (OH-Number, as KOH) can be determined by ASTM D4274, where ASTM D 1957 and ASTM E222-10 also describe methods of determining the hydroxyl number as provided herein; acid number (as KOH) were determined by ASTM D4662; and the isocyanate functionality was determined by ASTM D2572-19. the weight percent (wt. %) values provided for the isocyanate reactive composition (e.g., (a) through (d) are based on the total weight of the isocyanate reactive composition, where the total weight percent never exceeds 100 wt. %.

(a)—First Polyether Polyol

The isocyanate reactive composition includes (a) 50 to 90 weight percent (wt. %) of a first polyether polyol based on the total weight of the isocyanate reactive composition, where the first polyether polyol has 50 wt. % to 80 wt. % of moieties derived from ethylene oxide based on a total weight of the first polyether polyol, has a primary hydroxyl content of 30 percent to 78 percent based on a total number of hydroxyl groups in the first polyether polyol, and a hydroxyl number of 28 to 56 mg KOH/g. For the various embodiments, the first polyether polyol can have a functionality of 2 to 4. As used herein, functionality is the number of chemically active atoms or groups (e.g., —H, —OH, —NCO) per molecule for the considered reaction. This is used as an average value for the first polyether polyol.

The first polyether polyol is a reaction product of propylene oxide and/or ethylene oxide in the presence of a catalyst with an initiator which can be a diol, water, glycerin, TMP, or a multi-functional alcohol starter such as glycerol, sucrose or sorbitol, as are known in the art. The catalyst can be a strong base like potassium hydroxide or double metal cyanide (DMC) complexes as are known in the art. Specific examples of such reactions for forming the first polyether polyol of the present disclosure are found in U.S. Pat. No. 9,676,897 B2, which is incorporated herein by reference in its entirety.

The first polyether polyol can have a weigh average molecular weight (Mw) from 2,000 g/mol to 10,000 g/mol. For the various embodiments, all individual values and subranges from 2000 g/mol to 10,000 g/mol are included; for example, the first polyether polyol can have a Mw from a value of 2,000, 3,000 or 4,000 g/mol to an upper value of 5,000, 6,000 or 7,000 g/mol. The Mw can be measured from gel permeation chromatography (GPC) or light scattering techniques as are known.

The first polyether polyol can have a hydroxyl equivalent weight from 1,000 to 2,003 g/mol. As used herein, the hydroxyl equivalent weight is the weight of a compound per reactive site and is calculated according to the following equation: Equivalent Weight=(56.1×1000)/OH number. All individual values and subranges from 1,000 to 2,003 g/mol are included; for example, the first polyether polyol can have a hydroxyl equivalent weight from a lower limit of 1,000, 1,039, 1,058, or 1,079 to an upper limit of 1,145, 1,336, 1603, or 2000 g/mol.

The first polyether polyol also has a primary hydroxyl content of 30 percent to 78 percent based on a total number of hydroxyl groups in the first polyether polyol. All individual values and subranges of the primary hydroxyl content from 30 to 78 are included; for example, the first polyether polyol can have a primary hydroxyl content from a lower limit of 30, 40, 50, or 60 to an upper limit of 70, 72, 74, or 78.

The first polyether polyol further has a hydroxyl number of 28 to 56 mg KOH/g. The hydroxyl value and equivalent weight can be calculated based on each other. All individual values and subranges of the hydroxyl number from 28 to 56 mg KOH/g; for example, the first polyether polyol can have a hydroxyl number from a lower limit of 28, 30, 32, or 34 to an upper limit of 56, 54, 52, or 50.

The first polyether polyol has a functionality of 2 to 4. For the various embodiments, all individual values and subranges from 2 to 4 for the functionality of the first polyether polyol are included; for example, the first polyether polyol can have a functionality from a value of 2 or 2.5 to an upper value of 3, 3.5 or 4.

Commercial sources for the various embodiments of the first polyether polyol can include, but are not limited to, VORANOL™ polyether polyols available from The Dow Chemical Company.

For the various embodiments, the isocyanate reactive composition includes 50 to 90 wt. % of the first polyether polyol based on the total weight of the isocyanate reactive composition. All individual values and subranges from 50 to 90 wt. % of the first polyether polyol are included; for example, the first polyether polyol can be from a lower limit of 50, 55, 60 or 65 wt. % to an upper limit of 90, 85, 80, 75 or 70 wt. % of the total weight of the isocyanate reactive composition. For example, the first polyether polyol can be from 55 to 85 wt. %; 60 to 85 wt. %, 65 to 85 wt. % or 65 to 80 wt. % first polyether polyol based on the total weight of the isocyanate reactive composition.

(b)—Second Polyether Polyol

The isocyanate reactive composition includes (b) 10 to 50 wt. % of a second polyether polyol based on the total weight of the isocyanate reactive composition, where the second polyether polyol has 90 wt. % to 100 wt. % of moieties derived from propylene oxide based on a total weight of the second polyether polyol, has a primary hydroxyl content of 0 percent to 40 percent based on a total number of hydroxyl groups in the second polyether polyol, and a hydroxyl number of 25 to 88 mg KOH/g. For the various embodiments, the second polyether polyol can have a functionality, as defined herein, of 2 to 4, where the functionality is an average value for the second polyether polyol.

The second polyether polyol is a reaction product of propylene oxide and/or ethylene oxide in the presence of a catalyst with an initiator which can be a diol, water, glycerin, TMP, or a multi-functional alcohol starter such as glycerol, sucrose or sorbitol, as are known in the art. The catalyst can be a strong base like potassium hydroxide or double metal cyanide (DMC) complexes as are known in the art. Specific examples of such reactions for forming the first polyether polyol of the present disclosure are found in U.S. Pat. No. 9,676,897 B2, which is incorporated herein by reference in its entirety.

The second polyether polyol can have a weigh average molecular weight (Mw) from 1,200 g/mol to 9,000 g/mol. For the various embodiments, all individual values and subranges from 1,200 g/mol to 9,000 g/mol are included; for example, the second polyether polyol can have a Mw from a value of 1200, 1,600 or 2,000 g/mol to an upper value of 3,000, 5,000 or 9,000 g/mol. The Mw can be measured from GPC or light scattering techniques as are known.

The second polyether polyol can have a hydroxyl equivalent weight from 25 to 88 g/mol. All individual values and subranges from 25 to 88 g/mol are included; for example, the second polyether polyol can have a hydroxyl equivalent weight from a lower limit of 25, 32, 39, or 46 to an upper limit of 53, 60, 67, or 88 g/mol.

The second polyether polyol also has a primary hydroxyl content of 0 percent to 40 percent based on a total number of hydroxyl groups in the second polyether polyol. All individual values and subranges of the primary hydroxyl content from 0 to 40 are included; for example, the first polyether polyol can have a primary hydroxyl content from a lower limit of 0, 0.1, 0.2, or 0.3 to an upper limit of 10, 20, 30, or 40.

The second polyether polyol further has a hydroxyl number of 25 to 88 mg KOH/g. All individual values and subranges of the hydroxyl number from 25 to 88 mg KOH/g; for example, the second polyether polyol can have a hydroxyl number from a lower limit of 25, 28, 32, or 34 to an upper limit of 88, 82, 78, or 74.

The second polyether polyol has a functionality of 2 to 4. For the various embodiments, all individual values and subranges from 2 to 4 for the functionality of the second polyether polyol are included; for example, the second polyether polyol can have a functionality from a value of 2 or 2.5 to an upper value of 3, 3.5 or 4.

Commercial sources for the various embodiments of the second polyether polyol can include, but are not limited to, VORANOL™ polyether polyols available from The Dow Chemical Company.

For the various embodiments, the isocyanate reactive composition includes 10 to 50 wt. % of the second polyether polyol. All individual values and subranges from 10 to 50 wt. % of the second polyether polyol are included; for example, the second polyether polyol can be from a lower limit of 10, 15 or 20 to an upper limit of 50, 45, 40, 35 or 30 wt. % of the total weight of the isocyanate reactive composition. For example, the second polyether polyol can be from 15 to 45 wt. %; 15 to 40 wt. %; 20 to 35 wt. % or 20 to 30 wt. % second polyether polyol based on the total weight of the isocyanate reactive composition.

(c)—Polyether Siloxane Surfactant

The isocyanate reactive composition includes (c) 0.2 wt. % to 4.0 wt. % of the polyether siloxane surfactant, based on the total weight of the isocyanate reactive composition, of Formula (I):

R₁(CH₃)₂Si—[OSi(CH₃)₂]ₓ—[OSi(CH₃)(Y)]_{y}—OSi(CH₃)₂R₂ (Formula I)

where x is 5 to 55; y is 2 to 30; each Y is independently selected from the structure of Formula II:

—(CH₂)ₙO—(CH₂CH₂O)ₑ—(CH₂CH(R₃)O)ₚ—Z (Formula II)

where: n is 1 to 10; e is 5 to 12; p is 0 to 8; where the (CH₂CH₂O) e moiety of Formula II is at least 60 wt. % of the total weight of Formula II; where R₁, R₂, R₃ are independently selected from the group consisting of methyl, ethyl or phenyl; and Z is H. For the various embodiments, x can have a value of 5 to 15. For the various embodiments, y can also have a value of 2 to 10; or 2 to 4. For the various embodiments, n can also have a value of 2 to 8; 2 to 6; or 2 to 4. In one embodiment, the polyether siloxane surfactant can have x as 5 to 12; y as 2 to 4; p as 0 and R¹ and R² are each methyl, where R₃ can be ethyl. In an additional embodiment, the polyether siloxane surfactant can have x as 7 to 9; y as 3 to 4; p as 0; R₁ and R₂ are each methyl and R³ is ethyl.

For the various embodiments, the polyether siloxane surfactant can be prepared by hydrosilylation reaction of hydride functional siloxane and allyl polyether using known equipment and reaction conditions. In addition, a method of forming the polyether siloxane surfactant is provided in the examples section.

For the various embodiments, the isocyanate reactive composition includes 0.2 wt. % to 4.0 wt. % of the polyether siloxane surfactant. All individual values and subranges from 0.2 wt. % to 4.0 wt. % of the polyether siloxane surfactant are included; for example, the polyether siloxane surfactant can be from a lower limit of 0.2, 0.6 or 0.8 to an upper limit of 4.0, 3.0 or 2.0 wt. % of the total weight of the isocyanate reactive composition. For example, the polyether siloxane surfactant can be from 0.2 to 3.0 wt. %; 0.4 to 2.0 wt. % or 0.8 to 2.0 wt. % polyether siloxane surfactant based on the total weight of the isocyanate reactive composition.

(d)—Water

The isocyanate reactive composition can further include (d) up to 7 wt. % of water based on the total weight of the isocyanate reactive composition. All individual values and subranges from greater than 0 to 7 wt. % of the water (up to 7 wt. % of water) are included; for example, the water can be from a lower limit of 1, 2, 4 or 5 to an upper limit of 7, 6.5 or 6 wt. % of the total weight of the isocyanate reactive composition. For example, the water can be from 1 to 7 wt. %; 2 to 7 wt. %; 4 to 7 wt. % or 5 to 7 wt. % water based on the total weight of the isocyanate reactive composition.

For the various embodiments, the percentages for (a) through (d) are based on the overall weight of the isocyanate reactive composition and the total weight of (a) through (d) does not exceed 100%. In one embodiment, the isocyanate reactive composition can comprise components (a), (b), (c) and (d). In an additional embodiment, the isocyanate reactive composition can consist essentially of components (a), (b), (c) and (d). In a further embodiment, the isocyanate reactive composition can consist of components (a), (b), (c) and (d). It is also possible for the isocyanate reactive composition of the present disclosure to include other components, such as components (e) and (f), as discussed herein. For the various embodiments, when other components are present with (a), (b), (c) and (d) (e.g., (e) and (f) as provided herein), the percentages for the components (e.g., (a) through (f)) are based on the overall weight of the isocyanate reactive composition and the total weight of (a) through (f) does not exceed 100%.

(e)—Blowing Catalyst and (f) Gelling Catalyst

The isocyanate reactive composition of the present disclosure can further include (e) at least one blowing catalyst and (f) at least one gelling catalyst. For the various embodiments, the isocyanate reactive composition can include 0.01 to 0.1% by weight of the (e) at least one blowing catalyst. For the various embodiments, the isocyanate reactive composition can include 0.1 to 1% by weight of the (f) at least one gelling catalyst. As used herein, blowing catalysts and gelling catalysts, may be differentiated by a tendency to favor either the urea (blow) reaction, in the case of the blowing catalyst, or the urethane (gel) reaction, in the case of the gelling catalyst. For the various embodiments, the blowing catalyst and the gelling catalyst may include one or more of the blowing catalyst and/or the gelling catalyst as provided herein or as are known in the art.

Examples of blowing catalysts, e.g., catalysts that can tend to favor the blow reaction include, but are not limited to, short chain tertiary amines or tertiary amines containing oxygen. For instance, blowing catalysts include 2-((2-(2-(dimethylamino) ethoxy)ethyl) (methyl)amino) ethanol, bis-(2-dimethylaminoethyl) ether; pentamethyldiethylene-triamine, triethylamine, tributyl amine, N,N-dimethylaminopropylamine, dimethylethanolamine, N,N,N′,N′-tetra-methylethylenediamine, and combinations thereof, among others. Commercial examples of suitable blowing catalyst include those sold under the tradename JEFFCAT® from Huntsman International LLC.

Examples of gelling catalysts, e.g., catalyst that can tend to favor the gel reaction, include, but are not limited to, organometallic compounds, cyclic tertiary amines and/or long chain amines, e.g., that contain several nitrogen atoms, and combinations thereof. Organometallic compounds include organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate. Bismuth salts of organic carboxylic acids may also be utilized as the gelling catalyst, such as, for example, bismuth octanoate. Cyclic tertiary amines and/or long chain amines include dimethylbenzylamine, N,N,N′,N′-tetramethylbutanediamine, N,N-dimethylcyclohexylamine, N′-[3-(Dimethylamino) propyl]-N,N-dimethylpropane-1,3-diamine, triethylenediamine, and combinations thereof, and combinations thereof. Commercial examples of suitable gelling catalyst include those sold under the tradename DABCO® and POYCAT® from Evonik Industries AG.

For the various embodiments, the isocyanate reactive composition includes 0.01 to 0.1% by weight of the (e) at least one blowing catalyst and 0.1 to 1% by weight of the (f) at least one gelling catalyst. All individual values and subranges from 0.01 to 0.1 wt. % for the at least one blowing catalyst and 0.1 to 1% by weight for the at least one gelling catalyst included. For example, the blowing catalyst can be from a lower limit of 0.01, 0.02 or 0.04 to an upper limit of 0.1, 0.08 or 0.06 wt. % of the total weight of the isocyanate reactive composition. For example, the blowing catalyst can be from 0.01 to 0.08 wt. %; 0.02 to 0.06 wt. % or 0.04 to 0.06 wt. % blowing catalyst based on the total weight of the isocyanate reactive composition. The gelling catalyst can be from a lower limit of 0.1, 0.2 or 0.5 to an upper limit of 1, 0.8 or 0.7 wt. % of the total weight of the isocyanate reactive composition. For example, the gelling catalyst can be from 0.1 to 0.8 wt. %; 0.2 to 0.7 wt. % or 0.5 to 0.7 wt. % gelling catalyst based on the total weight of the isocyanate reactive composition.

### Viscoelastic Polyurethane Foam

The present disclosure further provides a viscoelastic polyurethane foam prepared from a composition that includes an isocyanate component and the isocyanate reactive composition of the present disclosure. For the various embodiments, the isocyanate component can comprise diphenyl methane diisocyanate (MDI), including 4,4′-MDI, 2,4′-MDI, and 2,2′-MDI), poly(diphenyl methane diisocyanate) or combinations thereof. As used herein, poly(diphenyl methane diisocyanate) refers to a molecule having an average of equal or greater than 2.0 isocyanate groups/molecule, e.g., an average functionality of greater than 2.0. For the various embodiments, the isocyanate component of the present disclosure can have a functionality of 2.0 to 3.0. It is also possible to use toluene diisocyanate in amounts that do not negatively affect the viscoelastic polyurethane foam of the present disclosure.

As mentioned, the isocyanate component can have an average functionality of greater than 1.0 isocyanate groups/molecule. For the various embodiments, the isocyanate component may be a prepolymer. For instance, the isocyanate component can have an average functionality from 2.0 to 3.2. All individual values and subranges from 2.0 to 3.2 are included; for example, the isocyanate component can have an average functionality from a lower limit of 2.0, 2.05, 2.10 or 2.15 to an upper limit of 2.3, 2.5, 2.7 or 3.0.

For the various embodiments, the stoichiometric index of the isocyanate component to the isocyanate reactive composition is 45 to 120. As known in the art, when the number of isocyanate groups of the isocyanate component equals the number of hydroxyl groups in the isocyanate reactive composition the result is a stoichiometric index of the isocyanate component to the isocyanate reactive composition of 1.0. When the number of isocyanate groups of the isocyanate component is greater than the number of hydroxyl groups in the isocyanate reactive composition (e.g., three times as many) the result is a stoichiometric index of the isocyanate component to the isocyanate reactive composition that is greater than 1.0 (e.g., 3.0 for the example).

The isocyanate component and isocyanate prepolymer can have an isocyanate equivalent weight 125 g/eq to 400 g/eq. All individual values and subranges from 125 g/eq to 400 g/eq are included; for example, the isocyanate component can have an isocyanate equivalent weight from a lower limit of 125, 128, 132 or 137 g/eq to an upper limit of 150, 200, 300 or 400 g/eq. In additional embodiments, the isocyanate component can have an NCO content from 10 to 35 percent by weight as determined by Spiegelberger's method (EN ISO 11909).

For the various embodiments, the viscoelastic polyurethane foam includes one, two or more surfactants of which at least 70 wt. % of the total weight of the two or more surfactants is the polyether siloxane surfactant of Formula (I), as discussed herein. In an additional embodiment, the isocyanate component of the present disclosure consists of at least 70 wt. % of diphenyl methane diisocyanate, poly(diphenyl methane diisocyanate) or combinations thereof based on the total weight of the isocyanate component.

The isocyanate component may be obtained commercially. Examples of commercial isocyanates include, but are not limited to, polyisocyanates under the trade names VORANATE™, PAPI™, ISONATE™, and VORALUX™, each available from The Dow Chemical Company, among other commercial isocyanates.

The present disclosure also includes a process of preparing the viscoelastic polyurethane foam that includes a step of reacting the components comprising the isocyanate component and the isocyanate reactive composition, both as provided herein. For example, for the various embodiments the components can be mixed at a temperature of from 15 to 90 °C, preferably from 20 to 60 °C and in particular from 20 to 35 °C. Mixing can be carried out mechanically by means of a stirrer or a stirring screw. Reaction temperature for the reaction mixture once dispensed can be from 20 to 110 °C, preferably from 30 to 70 °C and in particular from 40 to 60 °C.

One or more embodiments of the present disclosure provide that the composition for producing the viscoelastic polyurethane foam can include one or more additional components. Different additional components and/or different amounts of additional components may be utilized for various applications. Examples of additional components include pigments, colorants, hydrocarbon blowing agents, flame retardants as are known in art, crosslinkers, chain extenders such as ethylene glycol, propylene glycol, dipropylene glycol, tripropylene glycol, glycerine, etc., antioxidants, bioretardant agents, and combinations thereof, among others.

### EXAMPLES

In the Examples (Ex) and Comparative Examples (CE), various terms and designations for materials are used including, for instance, the following:

### Raw Materials

Polymethylhydrosiloxane, trimethylsilyl terminated (CAS 63148-57-2), octamethylcyclotetrasiloxane (CAS 56-67-2), and hexamethyldisiloxane (CAS Jan. 7, 2046-0) were purchased from Gelest, Inc. Trifluoromethanesulfonic acid (CAS 1493-13-6) and sodium bicarbonate (CAS 144-55-8) were purchased form Sigma-Aldrich. Allyl polyether materials 10 were purchased from various polyether suppliers such as NOF, Huang Ma, and Huntsman. If not specified, the polyols are made using KOH as the catalyst.

| | | Chemical Description, | |
|---|---|---|---|
| Ingredient | Product Trade | Chemical formula, or | |
| Type | Name | Structure | Source |
| Polyol 1 | VORANOL ™ | Average hydroxyl | The Dow |
| | | functionality about 2; | Chemical |
| | | Average hydroxyl number | Company |
| | | about 55 mg KOH/g; | |
| | | Propylene oxide based | |
| | | with 0 percent primary | |
| | | OH | |
| Polyol 2 | VORANOL ™ | Average hydroxyl | The Dow |
| | | functionality about 3; | Chemical |
| | | Average hydroxyl number | Company |
| | | about 33 mg KOH/g; | |
| | | Ethylene oxide content | |
| | | 78 weight percent with | |
| | | 43 percent primary OH | |
| Polyol 3 | VORANOL ™ | Average hydroxyl | The Dow |
| | | functionality about 3; | Chemical |
| | | Average hydroxyl number | Company |
| | | 37 mg KOH/g; | |
| | | Ethylene oxide content | |
| | | 78 weight percent with | |
| | | 92 percent primary OH | |
| Polyol 4 | VORANOL ™ | Average hydroxyl | The Dow |
| | | functionality about 2; | Chemical |
| | | Average hydroxyl number | Company |
| | | about 56 mg KOH/g; | |
| | | Propylene oxide based | |
| | | with 0 percent primary | |
| | | OH | |
| Polyol 5 | POLYGLYCOL ™ | Average hydroxyl | The Dow |
| | | functionality about 2; | Chemical |
| | | Average hydroxyl number | Company |
| | | about 50 mg KOH/g; | |
| | | about 7 percent | |
| | | ethylene oxide capped | |
| | | with about 50 percent | |
| | | primary OH | |
| Polyol 6 | VORANOL ™ | Average hydroxyl | The Dow |
| | | functionality about 3; | Chemical |
| | | Average hydroxyl number | Company |
| | | about 56 mg KOH/g; | |
| | | Propylene oxide based | |
| | | with 0 percent primary | |
| | | OH | |
| Polyol 7 | VORANOL ™ | Average hydroxyl | The Dow |
| | | functionality about 3; | Chemical |
| | | Average hydroxyl number | Company |
| | | about 56 mg KOH/g; | |
| | | Ethylene oxide content | |
| | | about 12 weight percent | |
| | | with about 1 percent | |
| | | primary OH | |
| Blowing | JEFFCAT ® | Blowing catalyst | Huntsman |
| Catalyst | | | |
| Gel | POLYCAT ® | Gel catalyst | Evonik |
| Catalyst | | chemical blowing agent | |
| Water | | | |
| (distilled) | | | |
| Isocyanate | VORALUX ™ | Polymethylene polyphenyl | The Dow |
| 1 | | isocyanate (PMDI), about | Chemical |
| | | 33% NCO content , | Company |
| | | viscosity @ 25 degC = | |
| | | 30 cP | |

### Siloxane Synthesis

Into a 3-neck round bottom flask equipped with a mechanical stirrer combine the components listed in Table 1 at the concentrations listed depending on the siloxane being made to form a mixture. The concentrations are in wt. % relative to combined weight of those components. Flush the reaction flask with nitrogen for several minutes and then shut off the nitrogen flow. Heat the mixture to 60 degrees Celsius (°C). Add 500 weight-parts per million weight parts mixture (ppm) trifluoromethanesulfonic acid as a catalyst and continue heating at 60 °C for 8 hours. Neutralize the mixture with sodium bicarbonate (10 grams per milliliter of acid catalyst added). Cool the mixture for 12 hours while stirring. Filter the mixture and remove volatile components from the liquid portion using vacuum distillation at 150 °C at 15 millimeters mercury for 5 hours. Characterize the resulting siloxane using ²⁹Si NMR and FTIR.

TABLE 1
Structures of Siloxane:
(CH₃)₃Si—[OSi(CH3)₂]ₓ—[OSi(CH₃)]_{y}—OSi(CH₃)₃

| | | | Polydimethyl | | |
|---|---|---|---|---|---|
| | | | hydrosiloxane, | Octamethyl | |
| | | | trimethylsilyl | cyclotetra | Hexamethlyl |
| | | | terminated | Siloxane | disiloxane |
| Siloxane | x | y | (wt. %) | (wt. %) | (wt. %) |
| A | 8.7 | 3.7 | 22.7 | 62.6 | 14.7 |
| B | 128.8 | 17.6 | 10.3 | 88.7 | 1.0 |
| C | 108 | 10 | 7.2 | 91.3 | 1.5 |

### Silicone Polyether Surfactant Synthesis

Combine the siloxane and APE to form a mixture in a 3-neck flask equipped with a mechanical stirrer, a thermocouple and a water-cooled condenser. Heat the mixture to 70 °C under a nitrogen flow and then add a Karstedt's catalyst via syringe (solution in isopropanol at 5 ppm Pt loading). The reaction mixture becomes turbid and generates heat causing the temperature of the mixture to rise to 90 °C. Monitor the reaction progress via tracking the SiH level using infrared (IR) spectroscopy (using a solution of reaction material in tetrachloroethylene) after the temperature increase subsides. The SiH level is determined by taking the peak integration at 2150 cm-1 compared to an external standard of known concentration. If the reaction mixture contains greater than 5% residual SiH, add an additional 5 ppm Pt. Hold the reaction at 90 °C until the SiH level is below 5% of the original amount as monitored by IR spectroscopy, up to 9 hours. Stop the reaction by cooling the mixture down to 25 °C. The resulting liquid is clear to slightly hazy golden and is used without further purification.

TABLE 2
Silicone Polyether Surfactants

| | | Siloxane | APE | | | | | |
|---|---|---|---|---|---|---|---|---|
| | Siloxane | wt. % | wt. % | e | p | R1, R2 | R3 | Z |
| Surfactant 1 | A | 27.0 | 73.0 | 11.2 | 0 | —CH₃ | CH₃CH₂— | H |
| Surfactant 2 | A | 27.0 | 73.0 | 11.2 | 0 | —CH₃ | CH₃CH₂— | Ac |
| Surfactant 3 | A | 17.2 | 82.8 | 0.18 | 18 | —CH₃ | CH₃CH₂— | H |
| Surfactant 4 | B | 14.1 | 85.9 | 14.9 | 9.9 | —CH₃ | CH₃CH₂— | Ac |
| Surfactant 5 | C | 17.4 | 82.6 | 18 | 18 | —CH₃ | CH₃CH₂— | Ac |

TABLE 3
EO %/PO % content and the capping information
for Silicone Polyether Surfactants

| | EO % | PO % |
|---|---|---|
| Surfactant 1 | 100.0 | 0.0 |
| Surfactant 2 | 100.0 | 0.0 |
| Surfactant 3 | 0.8 | 99.2 |
| Surfactant 4 | 53.7 | 46.3 |
| Surfactant 5 | 43.1 | 56.9 |

### Experimental Procedure

### Free Rising PU Foam Preparation

The free rise PU foam samples were made under a fume hood using a cardboard cylinder container lined with clear plastic film lining. The components in the formulation, except the isocyanate, were mixed first for 15 seconds at 1000 rpm. The formulated polyol and the isocyanate were then mixed for 5 seconds using the mixer at 1500 rpm. The mixer blade had a diameter of 2.0 inches. For each experiment, a total of 160 grams of materials (polyol system and isocyanate system) was used. Then the entire mixture was poured into the cylinder container lined with plastic film. Once foaming was complete, the foam was further allowed to cure overnight at room temperature under the fume hood.

### Pillow Preparation

The pillow foams were made using a standard-size pillow mold built out of aluminum. The mold has four ventilation holes on the top lid, which were blocked. The mold temperature was set at 135 °F. A 16-pin (4 pins each in four radial directions that are separated by) 90° mixer at high rotation speed was used. A 1-gallon cup was used as the container for mixing.

The components in the formulation were mixed first for 5 seconds at 2800 rpm. Then the entire mixture is poured into the mold which is pre-coated with a releasing agent. The mold is degassed at 130 seconds and the foam was demolded after 210 seconds.

### Properties Test

The flex foam was tested for density (reported in pounds per cubic foot, lbs/ft.³), compression force deflection (CFD), airflow (reported in scfi (standard cubic feet per minute, or ft³/min), according to ASTM D3574. The samples were conditioned in the lab at least 24 hours prior to the test, under conditions as indicated by ASTM D3574.

### Results

Influence of Silicone polyether surfactant allylic polyether capping: Surfactant 1 versus Surfactant 2. When Surfactant 2 (acetate capped surfactant) was used, the foam collapsed. When Surfactant 1 (not capped) was used, a suitable foam was formed. This is surprising as Surfactant 1 is a surfactant designed and suggested for rigid polyurethane foam applications. The foaming results at two different water levels, demonstrated that the silicone polyether surfactant allylic polyether side chain does not need to be acetate capped.

TABLE 4
Influence of Silicone Polyether Surfactant Allylic Polyether Capping

| | EX 1 | CE A | CE B | EX 2 | CE C | CE D |
|---|---|---|---|---|---|---|
| Polyol 1 (pphp) | 20 | 20 | 20 | 20 | 20 | 20 |
| Polyol 2 (pphp) | 80 | 80 | 80 | 80 | 80 | 80 |
| Water (pphp) | 5.5 | 5.5 | 5.5 | 6.53 | 6.53 | 6.53 |
| Surfactant 1 (pphp) | 1.0 | | | 1.0 | | |
| Surfactant 2 (pphp) | | 1.00 | 0.70 | | 1.00 | 0.70 |
| Blowing Catalyst (pphp) | 0.05 | 0.05 | 0.05 | 0.05 | 0.05 | 0.05 |
| Gel Catalyst (pphp) | 0.60 | 0.60 | 0.60 | 0.60 | 0.60 | 0.60 |
| Isocyanate Index (%) | 54.9 | 54.9 | 54.9 | 54.9 | 54.9 | 54.9 |
| Foaming result | Good | collapse | collapse | Good | collapse | collapse |
| Density pcf | 2.484 | N/A | N/A | 2.007 | N/A | N/A |
| Airflow scfm | 0.197 | N/A | N/A | 0.201 | N/A | N/A |
| CFD 25% Mpa | 0.58 | N/A | N/A | 1.21 | N/A | N/A |
| CFD 40% Mpa | 0.80 | N/A | N/A | 1.44 | N/A | N/A |
| CFD 65% Mpa | 1.49 | N/A | N/A | 2.46 | N/A | N/A |

pcf—pound per cubic foot. scfm—standard cubic feet per minute. pphp—parts per 100 parts polyol.

Silicone surfactant allylic polyether PO/EO content: Surfactant 1 versus Surfactant 3. Surfactant 3 is a surfactant with a similar structure to Surfactant 1 except for the PO content in the allylic polyether. Surfactant 3 is based on allyl-EO 0.18-PO 18—OH. In comparison with Surfactant 1 which has all EO chains, Surfactant 3 has more PO versus EO (ratio of PO:EO of 18:0.18). the foaming results in Table 5 show that the pendant allylic polyether for silicone polyether surfactant benefits from having a high EO content, where if the EO content is low, like in Surfactant 3, the foam stability will worsen and the foam will collapse. The following formulations use a water level of 5.5 pphp and of 6.53 pphp

TABLE 5
Silicone Surfactant Allylic Polyether PO/EO Content

| | EX 1 | CE E | CE F | CE G | EX 2 | CE H | CE I | CE J |
|---|---|---|---|---|---|---|---|---|
| Polyol 1 (pphp) | 20 | 20 | 20 | 20 | 20 | 20 | 20 | 20 |
| Polyol 2 (pphp) | 80 | 80 | 80 | 80 | 80 | 80 | 80 | 80 |
| DI Water (pphp) | 5.5 | 5.5 | 5.5 | 5.5 | 6.53 | 6.53 | 6.53 | 6.53 |
| Surfactant 1 (pphp) | 1.0 | | | | 1.0 | | | |
| Surfactant 3 (pphp) | | 1.50 | 1.00 | 0.70 | | 1.50 | 1.00 | 0.70 |
| Blowing Catalyst (pphp) | 0.05 | 0.05 | 0.05 | 0.05 | 0.05 | 0.05 | 0.05 | 0.05 |
| Gel Catalyst (pphp) | 0.60 | 0.60 | 0.60 | 0.60 | 0.60 | 0.60 | 0.60 | 0.60 |
| Isocyanate Index (%) | 54.9 | 54.9 | 54.9 | 54.9 | 54.9 | 54.9 | 54.9 | 54.9 |
| Foaming result | Good | collapse | collapse | collapse | Good | collapse | collapse | collapse |
| Density pcf | 2.484 | N/A | N/A | N/A | 2.007 | N/A | N/A | N/A |
| Airflow scfm | 0.197 | N/A | N/A | N/A | 0.201 | N/A | N/A | N/A |
| CFD 25% Mpa | 0.58 | N/A | N/A | N/A | 1.21 | N/A | N/A | N/A |
| CFD 40% Mpa | 0.80 | N/A | N/A | N/A | 1.44 | N/A | N/A | N/A |
| CFD 65% Mpa | 1.49 | N/A | N/A | N/A | 2.46 | N/A | N/A | N/A |

High EO polyol loading in the formulated polyol. Polyol 2 (a high EO polyol) forms from 50 to 90 parts of the total 100 parts of formulated polyol. In presence of very high loading of the high EO polyol, or in presence of loadings that are lower than 50 parts by weight in the formulated polyol, the foam performance is not acceptable: hence, a certain amount of high PO polyol (such as Polyol 1) is also present. Formulations testing various loadings of Polyol 3=high EO polyol that is meeting the scope of this Application.

TABLE 6
High EO Polyol Loading in the Formulated Polyol

| | CE K | EX 1 | EX 3 | CE L | CE M | CE N |
|---|---|---|---|---|---|---|
| Polyol 1 (pphp) | | 20 | 35 | 55 | 75 | 100 |
| Polyol 2 (pphp) | 100 | 80 | 65 | 45 | 25 | 0 |
| DI Water (pphp) | 5.5 | 5.5 | 5.5 | 5.5 | 5.5 | 5.5 |
| Surfactant 1 (pphp) | 1.0 | 1.0 | 1.0 | 1.0 | 1.0 | 1.0 |
| Blowing Catalyst (pphp) | 0.05 | 0.05 | 0.05 | 0.05 | 0.05 | 0.05 |
| Gel Catalyst (pphp) | 0.60 | 0.60 | 0.60 | 0.60 | 0.6 | 0.6 |
| Isocyanate Index (%) | 54.9 | 54.9 | 54.9 | 54.9 | 54.9 | 54.9 |
| Foaming | Foam | good | good | Foam CFD | Coarse cell | Does not |
| result | shrank | | | is too high | structure, | rise to full |
| | | | | | CFD too | height-30% |
| | | | | | high | only |
| Density pcf | Foam | 2.484 | 2.072 | 2.168 | 2.283 | Foam |
| Airflow scfm | cannot be | 0.197 | 0.355 | 0.214 | 0.136 | cannot be |
| CFD 25% Mpa | tested | 0.58 | 0.89 | 3.18 | 3.11 | tested |
| CFD 40% Mpa | | 0.8 | 1.12 | 4.47 | 4.68 | |
| CFD 65% Mpa | | 1.49 | 1.98 | 9.95 | 13.67 | |

The high EO polyol primary OH content: testing Polyol 2 versus Polyol 3. Polyol 2 is a mix-feed polyol and has a primary OH content of only about 40%. Polyol 3 has a very high primary OH content which is more than 90% of all OH groups. When Polyol 3 is used to make the pillow, a big portion of the pillow mold cavity is not filled. The foaming result indicates a high EO polyol with a high primary OH (EO capped polyol) content as the major polyol is not acceptable for the low-density pillow: the foam performance will improve using a high EO polyol with a medium primary OH (EO/PO mix feed polyol) content, the foaming example include Surfactants 4 and 5, which are acetate-capped silicone polyether surfactants. The example shows that the formulation contains a majority of the specific type of surfactant of the present disclosure (Surfactant 1), and additional surfactants may be used at a low content to adjust the processability and hand feeling of the foam formulation.

TABLE 7
High EO Polyol Primary OH Content::Polyol 2 versus Polyol 3

| | EX 4 | CE O |
|---|---|---|
| Polyol 1 (pphp) | 20.00 | 20.00 |
| Polyol 2 (pphp) | 80.00 | |
| Polyol 3 (pphp) | | 80.00 |
| DI Water (pphp) | 6.53 | 6.53 |
| Surfactant 1 (pphp) | 0.60 | 0.60 |
| Surfactant 4 (pphp) | 0.08 | 0.08 |
| Surfactant 5 (pphp) | 0.02 | 0.02 |
| Blowing Catalyst | 0.05 | 0.05 |
| (pphp) | | |
| Gel Catalyst (pphp) | 0.40 | 0.40 |
| Isocyanate Index | 53.2 | 53.2 |
| (%) | | |
| Pillow cavity fill | 100% | 80% |
| percentage | | |

High PO polyol: impact of primary OH content and of EO content. Polyol 1 and Polyol 4 and Polyol 6 are based on all PO and are considered to have close to 0% primary OH. the foaming results in Table 8 show that using large amount of a polyol with high PO content and with high primary OH (this corresponds to the case of EO capped polyol, like Polyol 5) is not acceptable. Polyol 7 has 12% EO; while Polyol 6 is based on all PO and has no EO: the foaming results suggest the PO polyol should not have a high EO content.

TABLE 8
High PO Polyol: Impact of Primary OH Content and of EO Content

| | EX 5 | EX 6 | CE P | EX 7 | CE Q | CE R |
|---|---|---|---|---|---|---|
| Polyol 1 (pphp) | 20.00 | | | | | |
| Polyol 4 (pphp) | | 20.00 | | | | |
| Polyol 5 (pphp) | | | 20.00 | | | |
| Polyol 6 (pphp) | | | | 20.00 | 10.00 | |
| Polyol 7 (pphp) | | | | | 10.00 | 20.00 |
| Polyol 2 (pphp) | 80.00 | 80.00 | 80.00 | 80.00 | 80.00 | 80.00 |
| DI Water (pphp) | 5.00 | 5.00 | 5.00 | 5.00 | 5.00 | 5.00 |
| Surfactant 1 (pphp) | 1.50 | 1.50 | 1.50 | 1.50 | 1.50 | 1.50 |
| Blowing Catalyst (pphp) | 0.05 | 0.05 | 0.05 | 0.05 | 0.05 | 0.05 |
| Gel Catalyst (pphp) | 0.60 | 0.60 | 0.60 | 0.60 | 0.60 | 0.60 |
| Isocyanate Index (%) | 54.9 | 54.9 | 54.9 | 54.9 | 54.9 | 54.9 |
| Foaming result | Good | Good | Shrinkage | Good | Slight | Shrinkage |
| | | | | | shrinkage | |
| Density pcf | 2.272 | 2.750 | N/A | 3.371 | 5.184 | N/A |
| Airflow scfm | 0.240 | 0.446 | N/A | 0.273 | 0.273 | N/A |
| CFD 25% Mpa | 0.21 | 0.29 | N/A | N/A | 0.54 | N/A |
| CFD 40% Mpa | 0.36 | 0.31 | N/A | 0.26 | 0.68 | N/A |
| CFD 65% Mpa | 0.61 | 0.46 | N/A | 0.38 | 1.11 | N/A |

N/A = not available

### Glass Transition Temperature

Example 8 was formed as described above for EX 1-7. Table 9 provides the composition of EX 8, along with the glass transition temperature for the foam, the glass transition temperature was measured according to ASTM E1640-18. the foam had a very high glass transition above ambient temperature. The foam has a low temperature sensitivity of 2.32. The temperature sensitivity is defined as the ratio of the elastomer modulus at 15 °C over the elastic modulus at 30 °C. The elastomer modulus was obtained by using an RSA-G2 Solids Analyzer.

TABLE 9
Tg of EX 8

| Ex 8 | |
|---|---|
| Polyol 1 | 20 |
| (pphp) | |
| Polyol 2 | 80 |
| (pphp) | |
| DI Water | 6.53 |
| (pphp) | |
| Surfactant 1 | 1.2 |
| (pphp) | |
| Blowing | 0.05 |
| Catalyst | |
| (pphp) | |
| Gel Catalyst | 0.4 |
| (pphp) | |
| Isocyanate | 53.2 |
| Index (%) | |
| Glass | 38.9 |
| transition | |
| Temp, °C | |
| Temperature | 2.32 |
| sensitivity, | |
| °C | |

1. An isocyanate reactive composition for preparing a viscoelastic polyurethane foam, comprising:
(a) 50 to 90 weight percent (wt. %) of a first polyether polyol based on the total weight of the isocyanate reactive composition, wherein the first polyether polyol has 50 wt. % to 80 wt. % of moieties derived from ethylene oxide based on a total weight of the first polyether polyol, has a primary hydroxyl content of 30 percent to 78 percent based on a total number of hydroxyl groups in the first polyether polyol, and a hydroxyl number of 28 to 56 mg KOH/g;
(b) 10 to 50 wt. % of a second polyether polyol based on the total weight of the isocyanate reactive composition, wherein the second polyether polyol has 90 wt. % to 100 wt. % of moieties derived from propylene oxide based on a total weight of the second polyether polyol, has a primary hydroxyl content of 0 percent to 40 percent based on a total number of hydroxyl groups in the second polyether polyol, and a hydroxyl number of 25 to 88 mg KOH/g;
(c) 0.2 wt. % to 4.0 wt. % of a polyether siloxane surfactant, based on the total weight of the isocyanate reactive composition, of Formula (I):
R₁(CH₃)₂Si—[OSi(CH₃)₂]ₓ—[OSi(CH₃)(Y)]_{y}—OSi(CH₃)₂R₂ (Formula I)
wherein x is 5 to 55; y is 2 to 30; each Y is independently selected from the structure of Formula II:
—(CH₂)ₙO—(CH₂CH₂O)ₑ—(CH₂CH(R₃)O)ₚ—Z (Formula II)
wherein: n is 1 to 10; e is 5 to 12; p is 0 to 8; where the (CH₂CH₂O) e moiety of Formula II is at least 60 wt. % of the total weight of Formula II; where R₁, R₂, R₃ are independently selected from the group consisting of methyl, ethyl or phenyl; and Z is H; and
(d) up to 7 wt. % of water based on the total weight of the isocyanate reactive composition, where a total wt. % of (a), (b), (c) and (d) does not exceed 100 wt. %.

2. The isocyanate reactive composition of claim 1, wherein for the polyether siloxane surfactant x is 5 to 15; y is 2 to 4; p is 0 and R₁ and R₂ are each methyl.

3. The isocyanate reactive composition of claim 1, wherein the first polyether polyol and the second polyether polyol each have a functionality of 2 to 4.

4. The isocyanate reactive composition of claim 1, wherein the isocyanate reactive composition includes 60 to 85 wt. % of the first polyol and 15 to 40 wt. % of the second polyol.

5. The isocyanate reactive composition of claim 1, wherein the isocyanate reactive composition includes 5 wt. % to 7 wt. % of water.

6. The isocyanate reactive composition of claim 1, wherein the isocyanate reactive composition consists essentially of (a), (b), (c) and (d).

7. A viscoelastic polyurethane foam, prepared from a composition comprising:
an isocyanate component, wherein the isocyanate component comprises diphenyl methane diisocyanate, poly(diphenyl methane diisocyanate) or combinations thereof; and
the isocyanate reactive composition of claim 1.

8. The viscoelastic polyurethane foam of claim 7, wherein the viscoelastic polyurethane foam includes two or more surfactants of which at least 70 wt. % of the total weight of the two or more surfactants is the polyether siloxane surfactant of Formula (I).

9. The viscoelastic polyurethane of claim 7, wherein the isocyanate component consists of at least 70 wt. % of diphenyl methane diisocyanate, poly(diphenyl methane diisocyanate) or combinations thereof based on the total weight of the isocyanate component.

10. A process of preparing a viscoelastic polyurethane foam, comprising a step of reacting the components comprising:
an isocyanate component, wherein the isocyanate component comprises diphenyl methane diisocyanate, poly(diphenyl methane diisocyanate) or a combination thereof; and
the isocyanate reactive composition of claim 1.
